(19) United States
(12) Patent Application Publication
(10) Pub. No.: US 2018/0173850 A1
(43) Pub. Date: Jun. 21, 2018

(54) System and Method of Semantic Differentiation of Individuals Based On Electronic Medical Records

(71) Applicants: Kevin Erich Heinrich, Collierville, TN (US); Ramin Homayouni, Memphis, TN (US); Bradford Ryan Silver, Memphis, TN (US)

(72) Inventors: Kevin Erich Heinrich, Collierville, TN (US); Ramin Homayouni, Memphis, TN (US); Bradford Ryan Silver, Memphis, TN (US)

(21) Appl. No.: 15/386,045

(22) Filed: Dec. 21, 2016

(51) Int. Cl. G06F 19/00

(52) U.S. Cl. CPC G06F 19/322; G06F 19/3443; G06F 19/328

(57) ABSTRACT

This document presents a system and method to extract highly meaningful terms from unstructured fields in an EMR that distinguish two different patient populations. Using this system, healthcare providers can quickly identify terms that are highly associated with a specific set of patients, for instance, chronic heart failure (CHF) patients who are high utilizers of the emergency department (ED) compared to CHF patients with low ED utilization. The system enables healthcare providers to identify root causes of health outcomes and to discover potential targets for intervention and improving healthcare delivery.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The Affordable Care Act of 2010 has prompted healthcare organizations to shift from a fee-for-service financial model to a value-based model. The goal of a value-based model is to deliver better quality care while lowering costs through developing patient-centered integrated care and support. Integrated care requires that providers take a holistic view of their patients and to understand the patient's unique characteristics and the full spectrum of their ailments. Integrated care approaches improve care and efficiency by allowing providers to develop an individualized care plan. While delivering targeted interventions on individual basis may not be cost-effective, segmentation of a population into groups of individuals with similar characteristics is tractable and proven to be effective in increasing the quality of care, lowering costs, and future hospital admissions. For instance, it has been shown that state-wide programs that identify elderly people who have unmet long-term care needs and connect them to Medicaid home and community based services lowered the annual Medicaid spending by 24%.

The growing adoption of electronic medical records (EMR) by providers has set the stage for integrated health care delivery. EMRs provide easy access to quantitative (e.g., laboratory and diagnostic test results) and qualitative (e.g., text-based discharge summaries) health data as well as transactional and financial data within and across multiple health systems. Experts urge the use of these rich data sources in EMRs for extraction of knowledge to improve decision making and care delivery.

Individualized healthcare requires that a physician has a comprehensive view of the patient's physical, behavioral, social and environmental conditions. People with multiple medical disorders and mental illness have a much higher risk of hospitalization, mortality and poor outcomes. To improve care by targeting interventions, analytical methods are being developed to identify individuals who are at risk of poor outcomes. Many of the risk prediction methods rely on structured data in the EMR such as lab results, diagnosis codes and procedure codes. However, better methods are needed that extract knowledge from the unstructured qualitative data in the EMR to have a deeper understanding of the complex characteristics of patients so that targeted interventions can be incorporated in their care delivery.

It is well known that structured data such as diagnosis codes (ICD9/10) alone cannot capture the complexities of individual patients. For example, structured data may indicate that a patient has late stage diabetes or uncontrolled diabetes, but it does not suggest possible causes. Knowing that a patient is not taking the prescribed medication because of the cost or access to a pharmacy can help the provider develop a more effective care plan. However, this type of qualitative information does not appear in the structured data, rather it appears in the unstructured text-based notes. Similarly, addressing the social and behavioral health of patients will improve treatment and management of physical disorders.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a flowchart representing the process of building a patient document corpus which is used to calculate term weights and to summarize patients consistent with certain embodiments of the present invention.

FIG. 2 is a flowchart representing the process of term differentiation to distinguish characteristics of a reference set of patients against a comparison set of patients consistent with certain embodiments of the present invention.

FIG. 3 is an embodiment of the system and method of the present invention that ranks distinguishing terms associated with a reference set of patients consistent with certain embodiments of the present invention.

FIG. 4 is a view of the patient record and corresponding term which is enriched in the reference group consistent with certain embodiments of the present invention.

FIG. 5 is a view of the patient record and corresponding term which is enriched in the reference group consistent with certain embodiments of the present invention.

FIG. 6 is a view of the patient record and corresponding term which is enriched in the reference group consistent with certain embodiments of the present invention.

FIG. 7 is a summary of the results of from automated semantic analysis system on a group of congestive heart failure patients consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

In an embodiment, a system and method is presented to extract highly meaningful terms from unstructured fields in an Electronic Medical Record (EMR) that distinguish two different patient populations. The differences between patient populations that, at a high level, may present similar symptoms and lead to the same diagnosis may provide healthcare professionals with information to more quickly and efficiently target populations of patients requiring broader or more targeted healthcare services. The system enables healthcare providers to identify root causes of health outcomes and to discover potential targets for intervention and improving healthcare delivery for segments of patient populations that may require broader or more substantial healthcare services. In a non-limiting example, using this system, healthcare providers can quickly identify terms that are highly associated with a specific set of patients, for instance, chronic heart failure (CHF) patients who are high utilizers of the emergency department (ED) compared to CHF patients with low ED utilization. An additional non-limiting example might be the identification of diabetic patients suffering from neuropathy within a larger population of diabetic patients overall.

In an embodiment, EMRs for all patients contain large amounts of descriptive and unstructured text from which data relevant to diagnosis, treatment, and prognosis may be gleaned. However, culling through this descriptive and unstructured text is a gargantuan task for which healthcare professionals have little time, given the caseload serviced by such professionals on a daily basis. The system and method provides analysis of this descriptive and unstructured text to identify and present to healthcare professionals categories of patients based upon pre-determined identifiers such as, in a non-limiting example, diagnosis, and sub-categories within these categories presenting distinguishing characteristics of the sub-category from the overall category. The system and method may create characterizations of patient populations for an overall category. Within that category, the system and method may identify terms, where terms may be single words or groupings of words, that distinguish a set of patients from the overall category and create a sub-category wherein the sub-category maintains the original identifier, but presents an additional identifier that serves to distinguish the patient population in the sub-category from the patient population in the overall category. The automated system may also utilize the sub-category patient population as a starting population and provide an analysis of the sub-category to create additional patient populations that have additional identifiers that further distinguish the additional populations from the patient population in the sub-category. In this manner, the automated system may derive multiple sets of patient populations that have characteristics and identifiers in common, but distinguish them from broader categories of patient populations.

In an embodiment, the automated system may be pre-configured with limits on the eligible terms to be applied to the patient populations when performing the textual analysis of the EMRs. The eligible terms may also be weighted on a percentage of interest to the healthcare professional to restrict the patient population discovered and to provide a ranking for patients in the discovered population. These configuration parameters permit the system to present the healthcare provider with ranked lists of patient categories and permit focus on only the terms most relevant to the healthcare provider from the patient EMRs.

In an embodiment, upon the conclusion of the semantic analysis of EMRs for requested or pre-configured terms, the patient populations, in any categorization, may be filtered and displayed to the healthcare professional according to various standard vocabularies in use in healthcare systems. Further filtering the patient population utilizing the terms from one or more standard vocabularies provides the ability to place patients identified at the top of the list of patients within a category or population. By way of example and not of limitation, vocabularies such as the Systematized Nomenclature of Medicine (SNOMED) or Federal Drug Agency (FDA) drug lists may be used as parameters by the system to further identify and categorize patient populations. Such vocabularies may permit the more rapid identification of patients within a population whose records contain text from these vocabularies. However, the two vocabularies presented are simply examples of vocabularies that may be pre-configured for use by the system, and the system may be configured to use any number of standard vocabularies for further analysis of EMRs based upon the instructions of a healthcare provider.

In an additional embodiment, the system and method may present to the healthcare professional records that are selected during semantic analysis for the reason that identifiers are found in the records, or because the identifiers are not found in the records. The identifiers may be defined by a healthcare professional as terms of interest for analysis of the EMRs. The healthcare professional may provide direction to the system to present records either containing or not containing terms that are of interest to the healthcare professional. This embodiment of the automated system provides the healthcare professional with lists of patients with terms of interest either highlighted or absent to quickly provide the healthcare professional which terms of interest are not found at the same prevalence in the reference set of patient records as distinguished from a comparison set of patient records.

The transformative nature of the system is such that users can quickly assess specific terms extracted from the unstructured fields in the EMRs of a group of patients to discover and explore unique characteristics. The system provides a decision-support tool for providers to understand the complexity of their patients and patient populations to develop targeted intervention or treatment strategies. The tool will assist providers to improve quality of care and to reduce cost for the healthcare system. Some examples of the transformative application of the semantic analysis system are provided below.

In an exemplary embodiment, the performance of the automated semantic analysis system in the identification of diagnoses from Physicians' notes as compared to analysis of discharge diagnosis codes alone for a group of patients with frequent ED visits are shown in TABLE 1. Typically, diagnosis codes underestimate the frequency of indications. In this non-limiting example, analysis of ICD9 codes revealed 19% of the frequent ED utilizers at an urban hospital were coded for schizophrenia. However, the automated semantic analysis system identified 51% of the frequent ED utilizers were associated with schizophrenia.

In this embodiment, it is important to note that other terms, such as homelessness and other terms, may not be represented in the diagnosis codes provided in discharge data, but may be highly relevant to delivery of high quality care to specific patients. Such additional terms may be specified by a healthcare professional to assist in identifying patients or groups of patients by screening for such terms that the healthcare professional has discovered, in their experience, may be ancillary, but relevant, to any particular discharge code or discharge data for ED utilizers. The automated semantic analysis system may then preferentially analyze physicians' notes for the defined terms either in association with particular discharge data records, or absent from particular discharge data records to provide the healthcare professional with patients that may require additional or more specific services. In this non-limiting example, the automated semantic analysis system identified 72% of the frequent ED utilizers at an urban hospital as being associated with the term ‘homeless.’ In addition, the automated semantic analysis system identified 65% of the frequent ED utilizers were associated with congestive heart failure (CHF), compared to only 3% found by analysis of ICD9 diagnosis codes utilized in the discharge data.

TABLE 1
Comparison of results from the invention to those from analysis
of ICD9 codes along for a group of 161 patients with frequent
ED visits at an urban 350-Bed Hospital in the United States.

| Analysis Based on Discharge Data | Semantic Analysis of |
|---|---|
| Alone | Physicians' Notes |
| 19% of ED patients had discharge | 51% have schizophrenia, based |
| diagnosis of schizophrenia | on physicians' notes. |
| 3% of admitted patients had CHF | 65% of admitted patients had a |
| discharge diagnosis. | physician's note related to |
| | CHF. |
| 0.0% of ED patients showed as | 72% of ED patients flagged as |
| homeless. | homeless. |

* CHF = congestive heart failure.

In an additional embodiment, as shown in TABLE 2, automated semantic analysis system has shown great utility in discovering a potential cause of admission in a subset of 1,267 patients out of a total of 3,466 patients in an oncology clinic. In the non-limiting example presented by TABLE 2, among the top terms associated with the admission group, three different formulations of granulocyte colony-stimulating factor drugs (Filgrastim, Pegilgrastim, and Sargramostim) were identified by the automated semantic analysis system as being present in physicians' notes for the patients of the clinic. These drugs are often given during chemotherapy to stimulate the production of white blood cells. Importantly, the system identified that Sargramostim was associated with 50% higher rate of hospital admission when compared to Pegfilgrastim alternative therapy. This result is consistent with a recent report entitled “Comparative effectiveness of filgrastim, pegfilgrastim and sargramostim as prophylaxis against hospitalization for neutropenic complications in patients with cancer receiving chemotherapy”. The authors reported that the risk of hospitalization was 2.1%, 1.1%, and 2.5% for filgrastim, pegfilgrastim and sargramostim, respectively. The adjusted odds of hospitalization were significantly higher for filgrastim and sargramostim compared to pegfilgrastim. The automated semantic analysis system discovered lower admission rates for patients receiving pegfilgrastim in the group of oncology patients examined. These results highlight the utility of the automated semantic analysis system in several ways. First, the automated semantic analysis system quickly identified risk factors associated with high admission rates of a subpopulation of oncology patients. Second, the automated semantic analysis system revealed areas were best-practices may not be implemented in a given provider group. Thus, using the automated semantic analysis system, healthcare providers may quickly identify areas for improving the quality of care specific to the patient population under their care.

TABLE 2
Frequency of hospital admissions for a group of
oncology patients who were associated with three
different drugs to stimulate white blood cells.

| | | No | Percent | | Prevented |
|---|---|---|---|---|---|
| Drug | Admit | Admit | Admitted | All Peg | Admits |
| Filgrastim | 449 | 991 | 31.2% | 300 | 149 |
| Pegfilgrastim | 498 | 1890 | 20.9% | 498 | — |
| Sargramostim | 320 | 585 | 35.4% | 189 | 131 |

In an embodiment, additional non-limiting examples of the transformative nature of the automated semantic analysis system for discovery and population health management include: 1) Identification of root cause of out-of-control diabetes within a group of 400 patients who, after 12-month diabetes program, were not able to lower their HbA1C below 8%, and 2) Identification of major cause of poor performing in-patients with stroke which, when addressed with appropriate treatment, decreased hospital costs by $2 million per year.

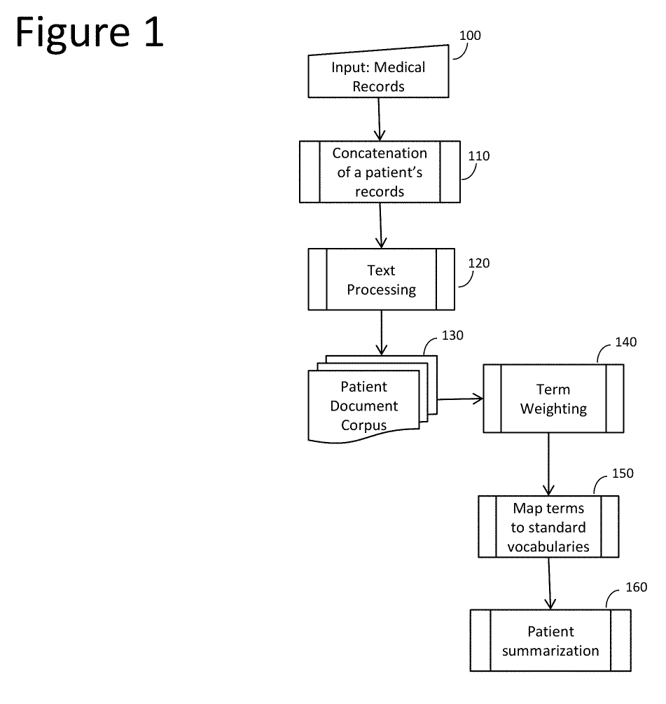

Turning now to FIG. 1, this figure is a flowchart representing the process of building a patient document corpus which is used to calculate term weights and to summarize patients consistent with certain embodiments of the present invention. In an exemplary embodiment, the system requires input of medical records 100 from a healthcare system, in any standardized format such as XML, HL7 or other standardized health record formats. The unstructured text fields for individual patients which may include all healthcare provider notes about the patient, treatment, or any other observations and comments are extracted from records dating back to the earliest encounter of that patient in the health system. The text from all unstructured text fields for each patient encounter may then be concatenated into one document 110. This document is retained for each individual patient in a secure electronic database for later retrieval and analysis by the system.

Upon creation or retrieval, the concatenated text document is processed using natural language processing methods 120 to remove lab results, negations (e.g. ‘patient does not have diabetes,’ or ‘the test result is negative for HIV,’ etc), or other comments and observations that have been defined by the healthcare provider. In addition, only a single family history and history-and-physical result is represented for each patient in a patient document to avoid inflation of terms for a given patient. The collection of all patient concatenated text documents in a particular healthcare system is represented in a patient document corpus 130. Any of a plurality of standard term weighting methods 140 (e.g. tf-idf, log entropy, etc) may be applied to the patient document corpus, such that each term in the patient document corpus is assigned a weight representing the frequency of the term in the patient's document with respect to the frequency of the term across all documents in the corpus. At 150, weighted terms may be mapped to a variety of standard vocabularies or ontologies (e.g. ICD9, CPT, SNOMED, FDA drug list, etc) to further identify, categorize, and characterize patient populations. Highly ranked terms and vocabulary/ontology classifications are provided to the healthcare provider by the system 160, to quickly summarize the highly relevant characteristics as associated with the attributes of interest defined for each patient in any given analysis effort. The automated semantic analysis system may then create patient populations with similar characteristics based upon these highly relevant characteristics.

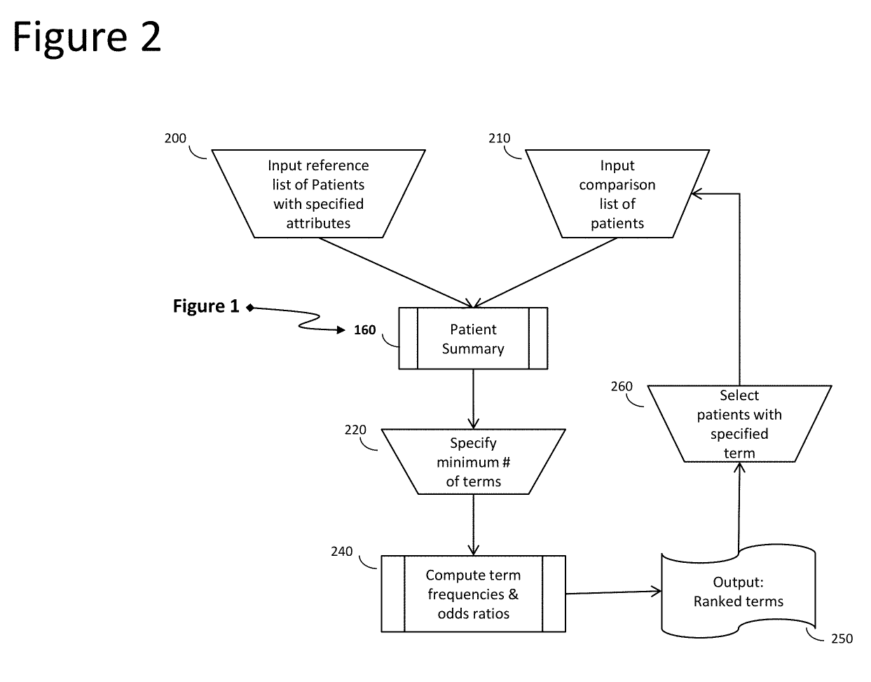

Turning now to FIG. 2, this figure presents a flowchart representing the process of term differentiation to distinguish characteristics of a reference set of patients against a comparison set of patients consistent with certain embodiments of the present invention. In an exemplary embodiment, the automated semantic analysis system requires an input patient reference list, at 200, which includes a list of patients which have any attribute of interest. Attributes of a patient may be selected from any of the weighted terms identified directly from a patient document or from any plurality of structured fields in a typical EMR system such as lab values, diagnosis codes, procedure codes, hospital admissions, duration of stay, cost, or any other term that may be present in patient documents in a typical EMR system. In a non-limiting example, attributes of interest may relate to frequent admission to the emergency department, frequent myocardial infarction, high cost of hospitalization, readmission, diabetes, or any other attribute the healthcare provider submits to the automated semantic analysis system.

In an exemplary embodiment, to continue an analysis of each patient against any patient population, the system requires the input of a patient population reference list, at 210, which includes a list of patients to be used for comparison against the patient reference list for each group of patients with specified attributes of interest. In a non-limiting example, the patient population reference list could be the entire population or a subset of patients which had good outcomes for a particular disease compared to bad outcomes. At 160, patient summarization data may be extracted from both the patient reference list and the patient population reference list. At 220, the user may define the minimum number of top ranked weighted terms to be used for comparisons during the list analysis step.

At 240, the system calculates differences in frequencies and odds ratios for terms between the reference input list and the patient population reference input lists. The frequency is calculated for each term t in R, where R is the patient reference list,

freq(t,R)=x(t,R)/|R|,

where x(t, R) is a count of patients that contain term t, where t represents an attribute of interest, the odds ratio may then be calculated for each term t with respect to R and S, where S is the patient population reference list,

odds(t)=freq(t,R)/freq(t,S),

where odds(t) is set to infinity when freq(t, S)=0.

In this exemplary embodiment, the automated semantic analysis system at 250 produces a ranked list of terms which differentiate between the two input patient lists. At 260, the user may select specific terms to produce a new patient population reference list and the process is re-iterated at step 160. The user selected terms are based on subjective analysis of the top ranked differentiating terms according to user's expertise and preferences. Once the term is selected, the system identifies all patients in the population whose records explicitly contain the term of interest. At this point, the user may choose a subset of patients identified to have the term of interest as a new reference population, upon which a new term differential analysis can be performed.

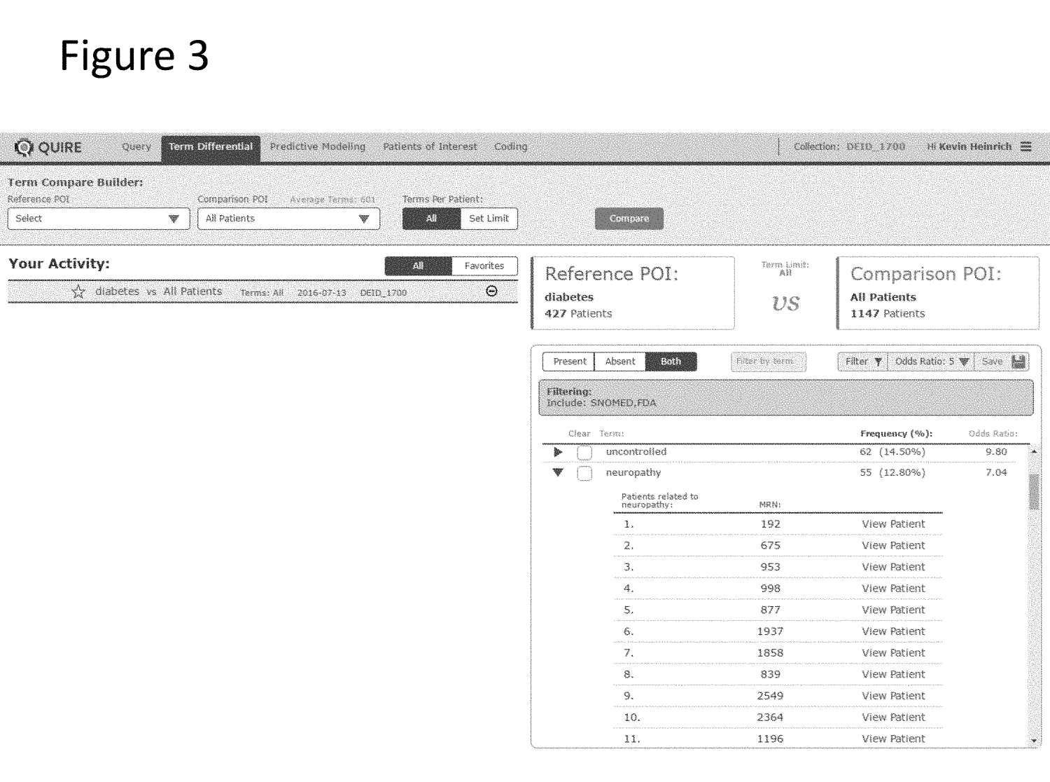

Turning now to FIG. 3, this figure presents an embodiment of the system and method of the present invention that ranks distinguishing terms associated with a reference set of patients consistent with certain embodiments of the present invention. In an exemplary embodiment, this figure provides a screenshot of the operation of the automated semantic analysis system where the user has selected a patient reference list of 427 diabetic patients and a patient population reference list of 1147 patients. The lists are referred to as Reference Patients of Interest (RPOI) and Comparison Patients of Interest (CPOI) in the system.

After computation, the system displays the results in a separate panel and records all of the activities of the user in a ‘History’ log and displays the activity in a different panel. The user may delete previous runs or designate specific runs as ‘Favorites’ by clicking on the star icon (⋆) for ease of future access. In the display panel, terms may be ranked based on frequency percentage or odds ratios in the reference list RPOI compared to the comparison list CPOI.

In an exemplary embodiment, in one analysis operation the system found that 55 patients (12%) in the RPOI were associated with the term ‘neuropathy.’ The odds that the term neuropathy appears in the records of the RPOI were 7.04 times higher than the odds of the term appearing in the records of the CPOI.

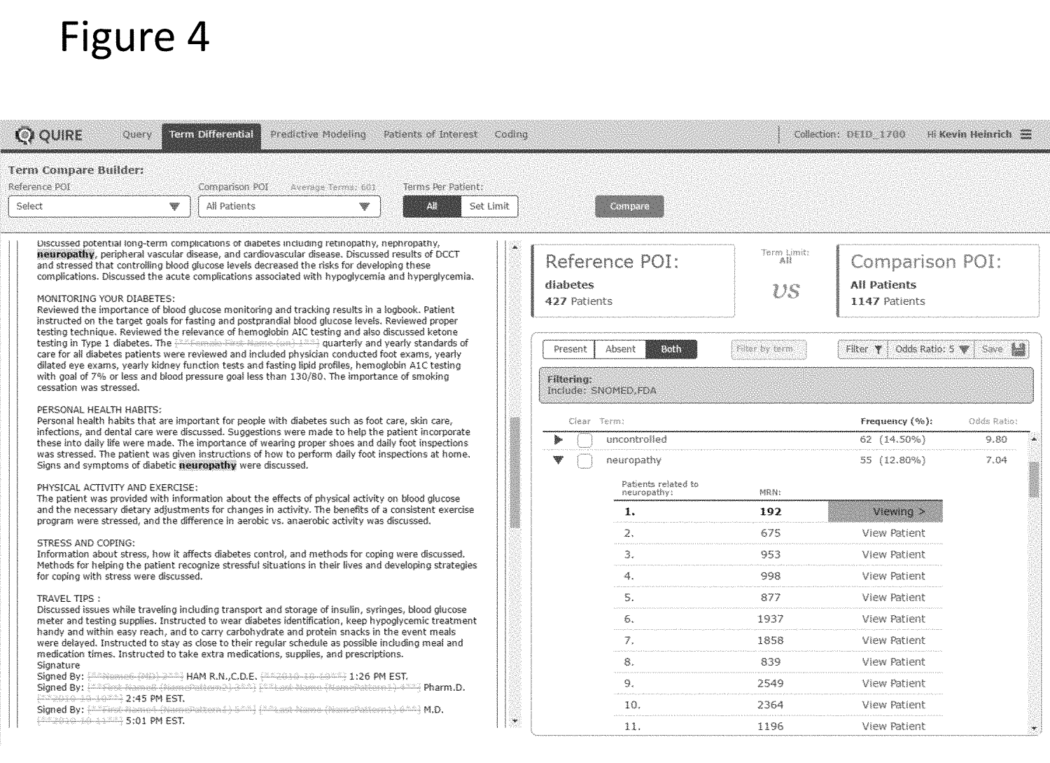

Turning now to FIG. 4, this figure presents a view of the patient record and corresponding term which is enriched in the reference group consistent with certain embodiments of the present invention. In an exemplary embodiment, each term heading may be expanded to view the patient identifiers for each patient in the list of patients who are associated with that term. The list of patients, including the patient identifiers for each patient, is presented to the user to permit the user to select any patient within the list of patients to review the unstructured text associated with the selected patient. The complete EMR of patients may be viewed by clicking on the patient ID number. The enriched term, or attribute of interest, is automatically highlighted in the patient record. The attribute of interest is highlighted in the expanded listing of the unstructured text extracted and compiled from EMRs in a panel that may be viewed by the user at the same time as the list of patient identifiers. In addition, a new POI may be created by selecting the subset of patients who are associated with a particular term. This new POI can be used in a new analysis effort by the semantic analysis system as either an RPOI or as part of the CPOI.

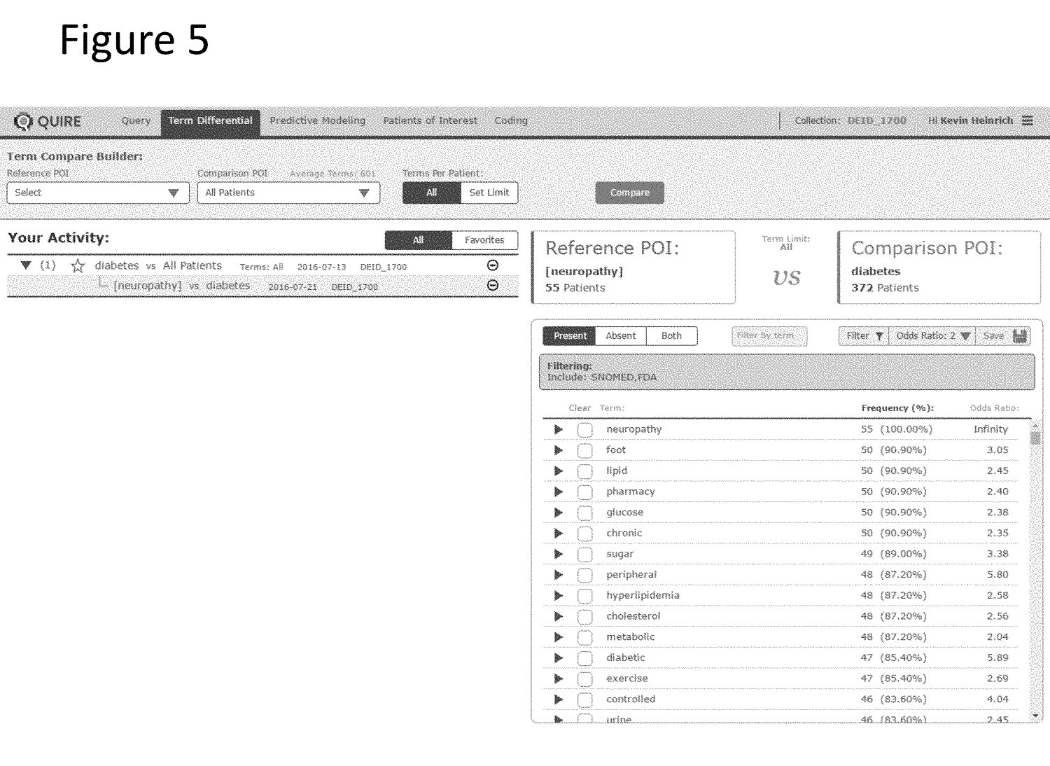

Turning now to FIG. 5, this figure presents a view of the patient record and corresponding term which is enriched in the reference group consistent with certain embodiments of the present invention. In this exemplary embodiment, the automated semantic analysis system logs, tracks, and manages the requested analysis efforts performed during an analysis session. During operation of the system if a subset of the RPOI is created, the results of the subsequent comparison are appended to the original analysis operation as shown in the screen shot of the system during operation. In this non-limiting example, the original analysis operation included the review of a subset of 427 diabetic patients compared to a group of 1147 patients. The user added an attribute of interest to further refine the list of patients that were of interest to the user. Any attribute of interest may be added at this point in the operation to attempt to refine the analysis of the system. In this non-limiting example the user added the attribute of interest of ‘neuropathy’ to further analyze the list of patients for this term in addition to the terms defined for the initial operation. In the subsequent operation, a subset of 55 diabetic patients associated with the word ‘neuropathy’ was compared to the remaining 372 diabetic patients from the newly established subset created during the initial operation. The user may choose whether the displayed terms are present in the reference group.

In this non-limiting example, odds ratios are computed for each highlighted attribute of interest that is present in the patient records. The frequency percentage is displayed to the user as freq(t, R). In this result, any highlighted terms quickly show which terms are not found at the same prevalence in the selected RPOI versus the CPOI utilized in the analysis.

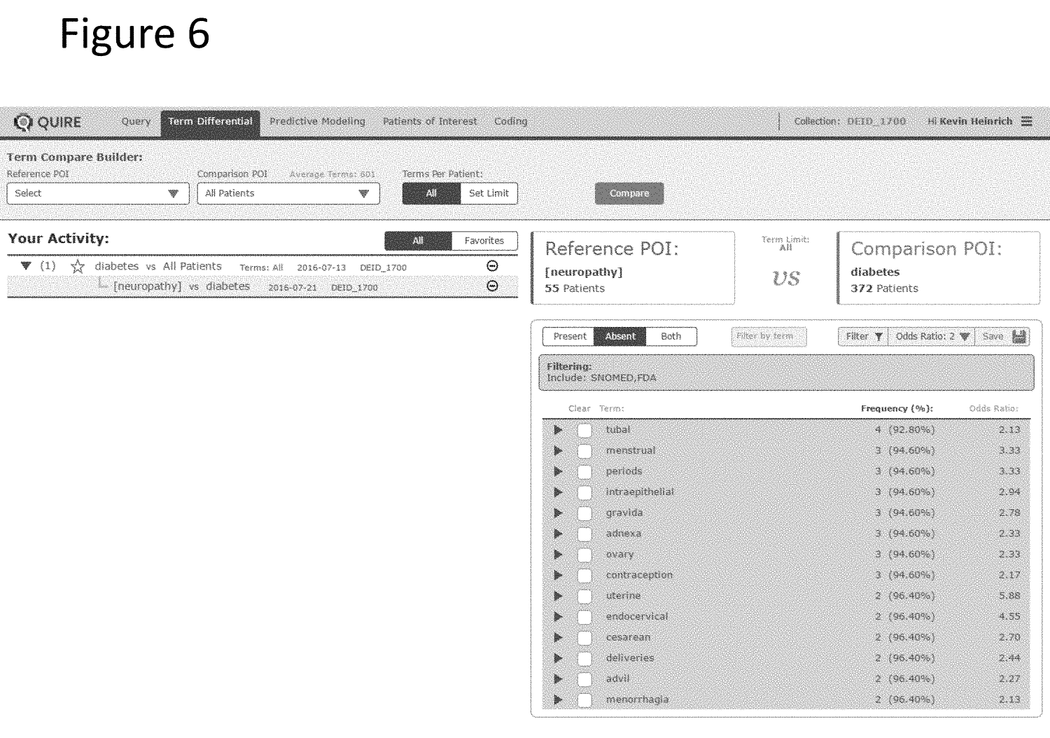

Turning now to FIG. 6, this figure presents a view of the patient record and corresponding term which is enriched in the reference group consistent with certain embodiments of the present invention. In this embodiment, the user may be provided with a list of attributes of interest for which the system will analyze the patient records for the absence of the selected attributes of interest in the reference group. Highlighted words such as tubal, menstrual, intraepithelial, etc were absent in the reference group of 55 neuropathy associated patients. In these cases, odds ratios are computed in the same manner as the computation utilized for attributes of interest that have been found in the patient records, however, the displayed odds ratio is inverted. Similarly, the frequency percentage displayed is 1−freq(t, R). As a result, any highlighted or “absent” terms quickly show which terms are not found at the same prevalence in the selected RPOI versus the CPOI utilized in the analysis.

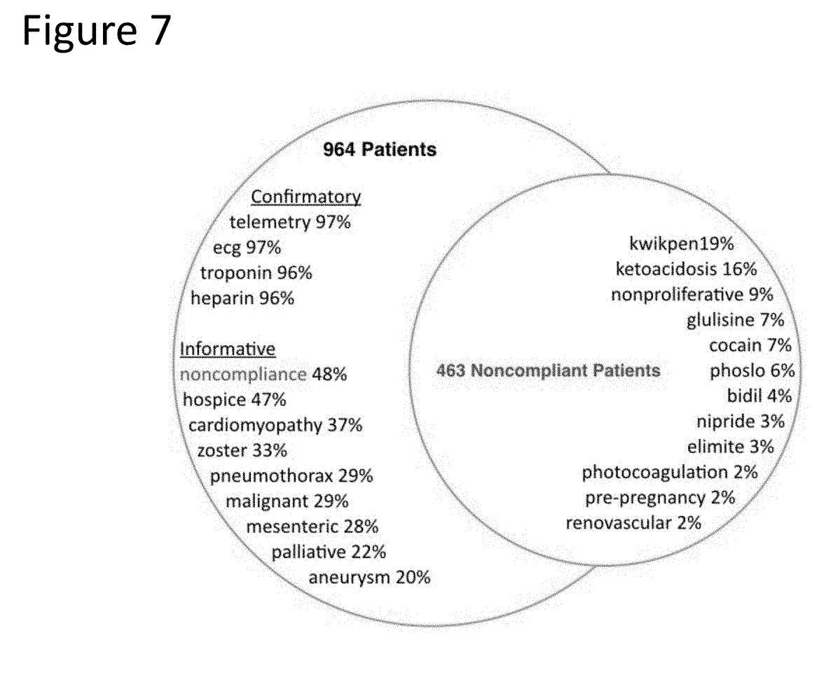

Turning now to FIG. 7, this figure presents a non-limiting example summary of the results from the automated semantic analysis system consistent with certain embodiments of the present invention. In this exemplary embodiment, this figure presents a summary of semantic analysis results after a comparison of 964 congestive heart failure patients having poor outcomes with respect to a reference list of 23,938 non-CHF patients. Based on a subject matter expert, some high frequency terms associated with the reference group were confirmatory with respect to CHF, such as ecg (97%), troponin (96%), and heparin (96%). However, other terms were found to be informative in identifying potential causes of the poor outcome. For example, 48% of the patients in the reference group were associated with the term ‘noncompliance.’ Further semantic analysis of a subset of 463 noncompliant CHF patients in the patient reference list showed association with ketoacidosis (16%), which is indicative of uncontrolled diabetes. With this information, the treatment protocol can be tailored to the needs of 74 patients who have CHF, are noncompliant, and have uncontrolled diabetes.

While certain illustrative embodiments have been described, it is evident that many alternatives, modifications, permutations and variations will become apparent to those skilled in the art in light of the foregoing description. By way of example and not of limitation, machine learning and natural language processing algorithms can be developed to further filter the differentiating terms between two patient populations to suggest clinically impactful terms. In addition, further improvements to the system would automatically suggest probabilistically favorable courses of action based on the term differential analysis to assist clinical decision support toward individual and population level health management.

We claim:

1. A system for text analysis to identify patient populations, comprising:
a processor having a data communication channel;
a module operable on said processor to receive one or more reference lists of patients and one or more comparison lists of patients and the text contained in the electronic medical record for each patient in the one or more reference lists of patients and one or more comparison lists of patients;
a module operable to analyze text within each reference list of patients and each comparison list of patients to prepare a patient summary result consisting of all compiled text associated with each patient identifier in each of the reference lists of patients and comparison lists of patients;
a module operable to place the patient summary result in electronic storage;
a module operable to accept as input from a user a set of terms and a minimum number of terms to be located in said patient summary result;
a module operable to analyze said patient summary result to discover and compile term frequencies and term ratios for all terms received from the user that differentiate between the one or more reference lists of patients and one or more comparison lists of patients;
a module operable to output to the user patient identifiers, term frequencies, and term ratios ranked in a pre-configured order for all terms input by the user.

2. The system of claim 1, further comprising the user selecting one or more patient identifiers having a discovered term and directing the system to place each patient identifier in a comparison list of patients to create one or more updated comparison lists of patients.

3. The system of claim 2, further comprising preparing an updated patient summary of terms utilizing one or more updated comparison lists of patients.

4. The system of claim 1, where the text in the electronic medical records for each patient in the one or more reference lists of patients and one or more comparison lists of patients comprises the unstructured text fields for individual patients including all healthcare provider notes about the patient, treatment, or any other observations and comments.

5. The system of claim 1, where the text analysis is performed by an automated semantic analysis system that compares the one or more reference lists of patients and one or more comparison lists to identify terms input by a user that are associated with any patient identifier.

6. The system of claim 1, where the compiled text is compiled through the association of a pre-configured weighting of terms.

7. The system of claim 1, where the compiled text is compiled by mapping terms to standard vocabularies associated with medical notes input by a medical practitioner in electronic medical records.

8. The system of claim 1, where the ranking of terms to be discovered is input by the user to discover terms associated with one or more particular diagnoses.

9. The system of claim 1, where the frequency of terms to be discovered is comprised of the number of times each term is discovered divided by the number of patient identifiers in the one or more reference lists of patients.

10. The system of claim 1, further comprising the generation of an odds ratio that calculates the number of times a term of interest appears in the one or more comparison patient lists divided by the number of times the same term of interest appears in the one or more reference patient lists.

11. A method for text analysis to identify patient populations, comprising:
receiving one or more reference lists of patients and one or more comparison lists of patients and the text contained in the electronic medical record for each patient in the one or more reference lists of patients and one or more comparison lists of patients;
compiling a text record for each patient identifier to prepare a patient summary text record consisting of all compiled text associated with each patient identifier in each of the reference lists of patients and comparison lists of patients
analyzing text within each reference list of patients and each comparison list of patients to prepare a patient summary result composed of text from all patient identifiers containing one or more pre-identified terms of interest;
placing the patient summary result in electronic storage;
accepting as input from a user a set of terms and a minimum number of terms to be located in said patient summary result;
analyzing said patient summary result to discover and compile term frequencies and term ratios for all terms received from the user that differentiate between the one or more reference lists of patients and one or more comparison lists of patients;
reporting to the user patient identifiers, term frequencies, and term ratios ranked in a pre-configured order for all terms input by the user.

12. The method of claim 11, further comprising the user selecting one or more patient identifiers having a discovered term and directing the system to place each patient identifier in a comparison list of patients to create one or more updated comparison lists of patients.

13. The method of claim 12, further comprising preparing an updated patient summary of terms utilizing one or more updated comparison lists of patients.

14. The method of claim 11, where the text in the electronic medical records for each patient in the one or more reference lists of patients and one or more comparison lists of patients comprises the unstructured text fields for individual patients including all healthcare provider notes about the patient, treatment, or any other observations and comments.

15. The method of claim 11, where the text analysis is performed by an automated semantic analysis system that compares the one or more reference lists of patients and one or more comparison lists to identify terms input by a user that are associated with any patient identifier.

16. The method of claim 11, where the compiled text is compiled through the association of a pre-configured weighting of terms.

17. The method of claim 11, where the compiled text is compiled by mapping terms to standard vocabularies associated with medical notes input by a medical practitioner in electronic medical records.

18. The method of claim 11, where the ranking of terms to be discovered is input by the user to discover terms associated with one or more particular diagnoses.

19. The method of claim 11, where the frequency of terms to be discovered is comprised of the number of times each term is discovered divided by the number of patient identifiers in the one or more reference lists of patients.

20. The method of claim 11, further comprising the generation of an odds ratio that calculates the number of times a term of interest appears in the one or more comparison patient lists divided by the number of times the same term of interest appears in the one or more reference patient lists.
